(19) United States
(12) Patent Application Publication
(10) Pub. No.: US 2019/0182600 A1
(43) Pub. Date: Jun. 13, 2019

(54) SPEAKER ASSEMBLY AND ELECTRONIC DEVICE USING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEN-JUAN LIU, Shenzhen (CN); ZHI-YONG JIN, Shenzhen (CN); LI LIANG, Shenzhen (CN)

(21) Appl. No.: 16/019,684

(22) Filed: Jun. 27, 2018

(30) Foreign Application Priority Data
Dec. 13, 2017 (CN) 201711332459.1

(51) Int. Cl. H04R 9/06; H04R 1/02; H04R 7/12; H04R 9/04

(52) U.S. Cl. CPC H04R 9/06; H04R 1/025; H04R 2307/021; H04R 9/046; H04R 7/12

(57) ABSTRACT

A speaker assembly includes a sound chamber, a speaker and a diaphragm. The speaker is set at one end of the sound chamber. The diaphragm is set at one side of the sound chamber. The sound chamber, the speaker and the diaphragm form a closed cavity, thus to reduce the high tone from the speaker to a mid-bass pitch. An electronic device using the speaker assembly is also provided.

### FIELD

The present disclosure relates to audio production.

### BACKGROUND

Mobile phones, personal digital assistants, tablets, laptops, and the like have built-in speaker assemblys that act as sound sources. With the improvement of playback quality of electronic devices, vibrations of audio playback can affect the normal operation of other electronic components inside the electronic devices. In limited space, most of the speaker assemblys are only tweeters without bass speaker assemblies, which may lead to sharp high-pitched and broken sounds and result in poor sound quality playback of the speaker assemblies.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a functional block diagram of an embodiment of an electronic device.

FIG. 2 is a schematic view of an embodiment of a speaker assembly of the electronic device of FIG. 1.

FIG. 3 is a disassembled view of the speaker assembly of FIG. 2.

FIG. 4 is a schematic view of one speaker assembly.

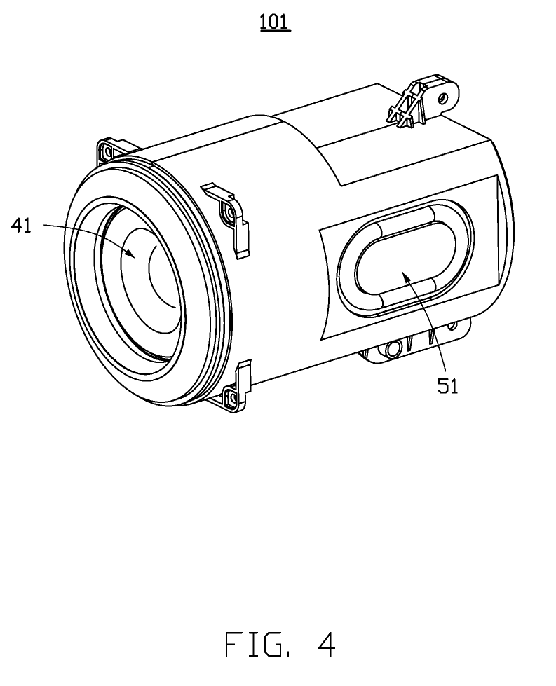

FIG. 5 is a disassembled view of the speaker assembly of FIG. 4.

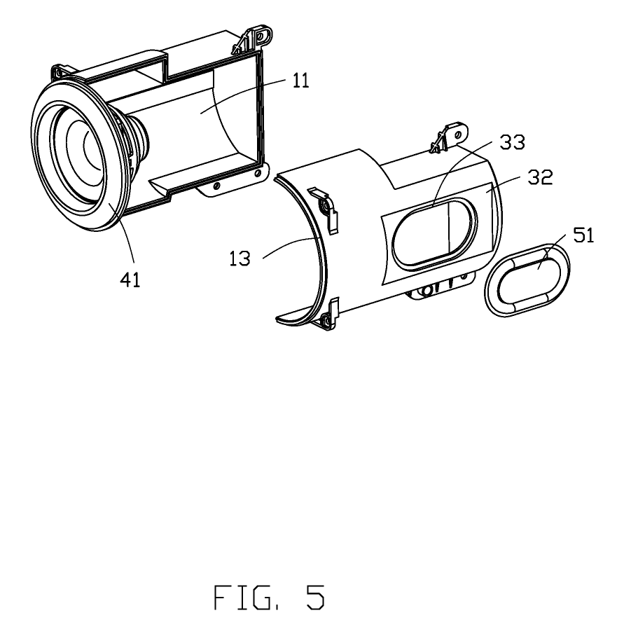

FIG. 6 is a disassembled view of a left channel speaker.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising” means “including, but not necessarily limited to”; it specifically indicates open-ended inclusion or membership in a so-described combination, group, series, and the like.

Embodiments of the present disclosure will be described in relation to the accompanying drawings.

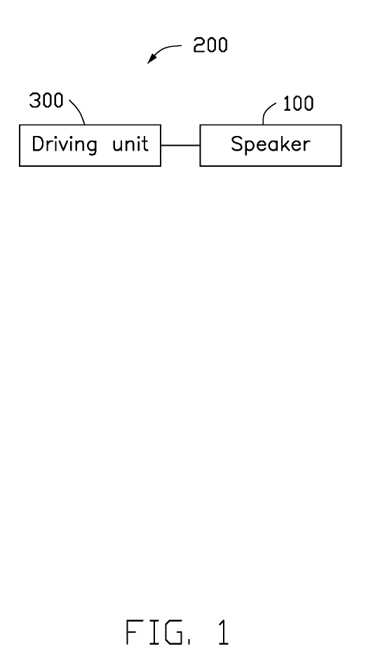

With reference to FIG. 1, an electronic device 200 includes a speaker assembly 100 and a driving unit 300. The driving unit 300 is configured to drive the speaker assembly 100. The electronic device 200 can be a mobile phone, a personal digital assistant, a tablet, a laptop or other electronic device having a sound outputting function. The electronic device 200 can further include, but is not limited to, other mechanical structures, electronic components, modules, and stored software.

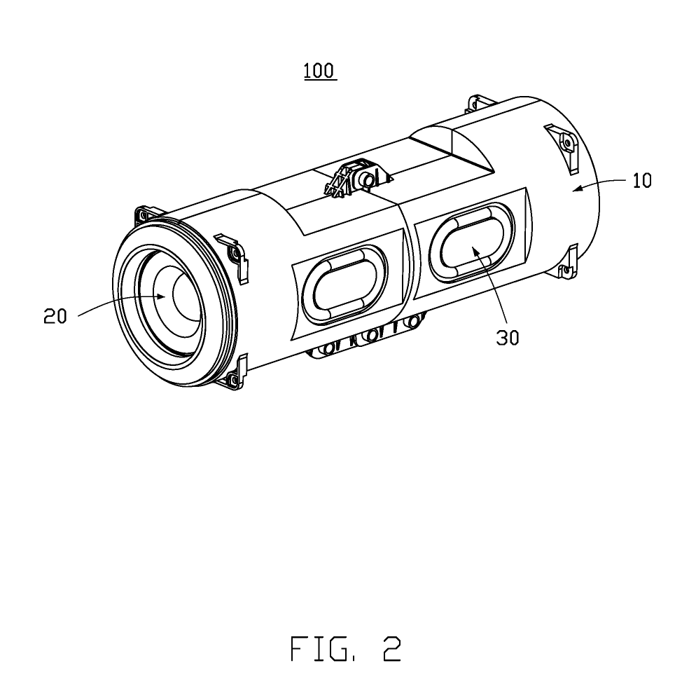

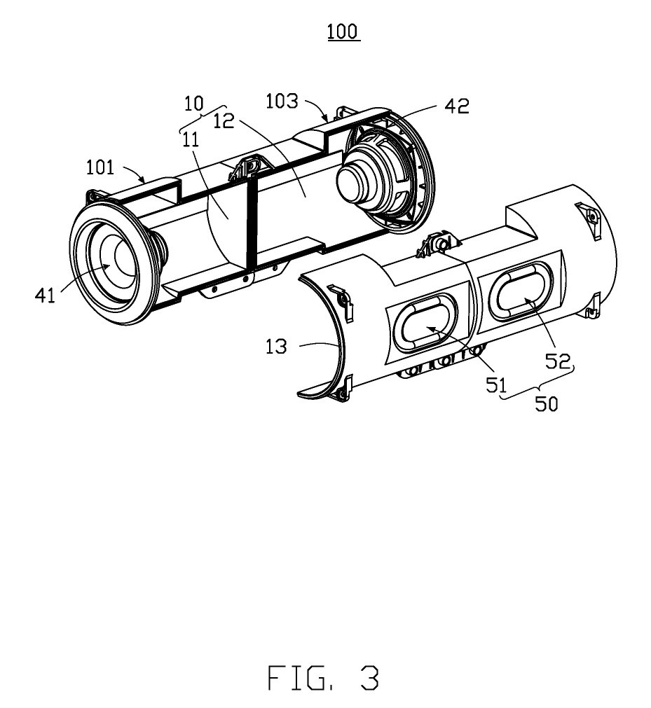

With reference to FIG. 2 and FIG. 3, an embodiment of a speaker assembly 100 is installed in the electronic device 200. The speaker assembly 100 can include, but is not limited to, at least one speaker sub-assembly. In the embodiment, the speaker assembly 100 includes two speaker sub-assemblies defined as a left speaker assembly 101 and a right speaker assembly 103.

The speaker assembly 100 includes a sound chamber 10, a speaker 20, and a diaphragm 30. Each speaker sub-assembly includes a sound chamber, a speaker, and a diaphragm.

In the embodiment, the left speaker assembly 101 includes a left sound chamber 11, a left speaker 41, and a left diaphragm 51. The right speaker assembly 103 has an exactly same structure, and includes a right sound chamber 12, a right speaker 42, and a right diaphragm 52.

The left speaker 41 is set at one end of the left sound chamber 11 and the right speaker 42 is set at one end of the right sound chamber 12. The end of the left sound chamber 11 and the end of the right sound chamber 12) are far away from each other. The other ends of each of the left and right sound chambers 11 and the right sound chamber 12 are together and fitted to each other to form the sound chamber 10. The left diaphragm 51 is set at one side of left sound chamber 11 and the right diaphragm 52 is set at one side of the right sound chamber 12. The left diaphragms 51 and the right diaphragm 52 are on the same side of the electronic device 200. The left sound chamber 11, the left speaker 41, and the left diaphragm 51 form a closed sound cavity. The right sound chamber 12, the right speaker 42, and the right diaphragm 52 form another closed sound cavity. The left speaker 41 and the right speaker 42 can each further include, but not be limited to, other mechanical structures, electronic components, modules, and stored software.

The left sound chamber 11 and the right sound chamber 12 are separated from each other. Each of the left sound chamber 11 and the right sound chamber 12 are substantially cylindrical. The left sound chamber 11 and the right sound chamber 12 each has a first end disposed near each other. The two first ends are independent of each other and are closed. The left sound chamber 11 and the right sound chamber 12 each has a second end which is opposite to a corresponding first end. The second ends each is a concave structure, and is concaved towards the corresponding first end. The second end forms a first opening 13 therein. The first openings 13 of the left sound chamber 11 and the right sound chamber 12 are configured to receive the left speaker 41 and the right speaker 42.

A description of only the left sound chamber 11, the left speaker 41, and the left diaphragm 51 needs to be given as examples for both the left sound chamber 11 and the right sound chamber 12.

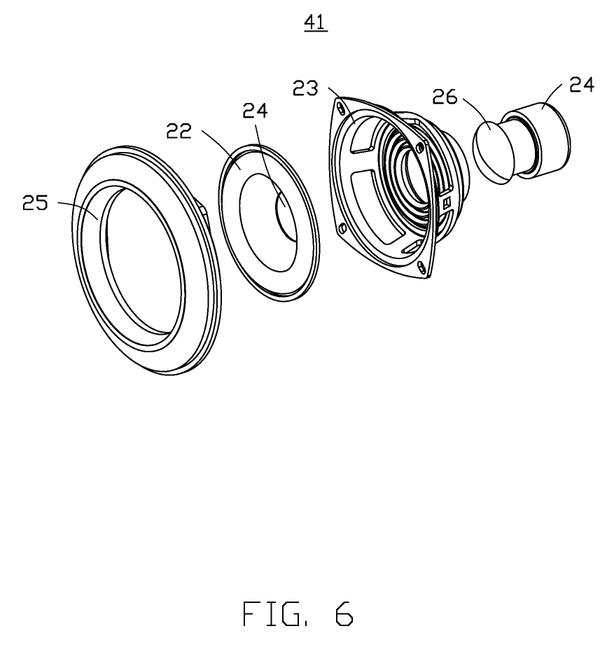

With reference to FIG. 6, the left speaker 41 includes a drum paper 22, a support portion 23, and a voice coil 24. The left speaker 41 is received in the first opening 13 of the left sound chamber 11. In the present embodiment, the left speaker 41 can be a high-frequency loudspeaker assembly. In other embodiment, the left speaker 41 can be an alto speaker and a bass speaker. The drum paper 22 is received in the second opening 25. The drum paper 22 is a trumpet-shaped structure. The drum paper 22 defines a third opening 14 therein. The third opening 14 is configured to receive a dust cap 26, and the dust cap 26 prevents the ingress of dust and other contaminants. The third opening 14 is an oval structure.

In the present embodiment, the support portion 23 has a threaded connection with the left sound chamber 11. In other embodiment, the connecting of the support portion 23 with the left sound chamber 11 can be achieved by a clamped or other connection. The support portion 23 is configured to secure the drum paper 22. A bottom of the voice coil 24 is secured to an end of second opening 14 of drum paper 22. In the present embodiment, the left speaker 41 can further include other mechanical and electronic elements.

The left diaphragm 51 is positioned at one side of the left sound chamber 11. The left sound chamber 11 defines a recess 32, the recess 32 is a rectangular structure. The recess 32 defines a fourth opening 33. The fourth opening 33 is an oval structure. The fourth opening 33 has a shape and size approximately the same as that of the diaphragm 30. The fourth opening 33 is configured to receive the diaphragm 30.

In the present embodiment, when the left speaker 41 receives an electrical audio signal alternating electric current passes through the coil on the left speaker 41 and electromagnetic induction produces sound as the drum paper 22 is vibrated.

The drum paper 22 vibrates the air in the closed space of the sound chamber but such air acts as a damper. This reduces the high frequencies of the left speaker 41 to a mid-bass pitch or tone. At the same time, the left diaphragm 51 can vibrate as the air in the closed space of the rear cavity is compressed or stretched due to the vibration of drum paper 22, and these vibrations of the diaphragm 51 convert the mid-bass pitch to a lower bass frequency or pitch.

The embodiments shown and described above are only examples. Many details are often found in the art such as the other features of a speaker assembly. Therefore, many such details are neither shown nor described. Even though numerous characteristics and advantages of the present technology have been set fourth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A speaker assembly comprising:
a sound chamber;
a speaker; and
a diaphragm;
the speaker is set at one end of the sound chamber, the diaphragm is set at one side of the sound chamber, the sound chamber, the speaker and the diaphragm form a closed sound cavity, thus to reduce the high tone from the speaker to a mid-bass pitch.

2. The speaker assembly of claim 1, wherein the sound chamber comprises:
a left sound chamber; and
a right sound chamber, the left sound chamber and the right sound chamber are separated from each other, each of the left sound chamber and the right sound chamber are substantially cylindrical.

3. The speaker assembly of claim 2, wherein the speaker comprises:
a left speaker; and
a right speaker, the left speaker is set at one end of the left sound chamber and the right speaker is set at one end of the right sound chamber, and the end of the left sound chamber and the end of the right sound chamber are far away from each other.

4. The speaker assembly of claim 2, wherein the diaphragm comprises:
a left diaphragm; and
a right diaphragm, the left diaphragm is set at one side of the left sound chamber and the right diaphragm is set at one side of the right sound chamber.

5. The speaker assembly of claim 2, wherein the opposite ends of the left sound chamber and the right sound chamber are provided with a first opening, the first opening is a concave structure, and the concave direction of the first opening of the left sound chamber is pointed to the other end of the left sound chamber.

6. The speaker assembly of claim 5, wherein the first opening is configured to receive the left speaker and the right speaker.

7. The speaker assembly of claim 2, wherein the left sound chamber and the right sound chamber each defines a recess, the recess is a rectangular structure.

8. The speaker assembly of claim 7, wherein the recess defines a second opening, the second opening is an oval structure.

9. The speaker assembly of claim 8, wherein the second opening is configured to receive the diaphragm.

10. The speaker assembly of claim 5, wherein the speaker further comprises a drum paper, the drum paper is received in a third opening.

11. The speaker assembly of claim 11, wherein the speaker further comprises a support portion, the support portion is configured to support the drum paper.

12. The speaker assembly of claim 11, wherein the speaker further comprises a voice coil, the drum paper defines a fourth opening, a bottom of the voice coil is secured to an end of the fourth opening.

13. The speaker assembly of claim 12, wherein the fourth opening is configured to receive a dust cap.

14. An electronic device comprising:
a speaker assembly comprising:
a sound chamber;
a speaker; and
a diaphragm; and
a driving unit configured to drive the speaker;
the speaker is set at one end of the sound chamber, the diaphragm is set at one side of the sound chamber, the sound chamber, the speaker and the diaphragm form a closed sound cavity, thus to reduce the high tone from the speaker to a mid-bass pitch.

15. The electronic device of claim 14, wherein the sound chamber comprises:
a left sound chamber; and
a right sound chamber, the left sound chamber and the right sound chamber are separated from each other, each of the left sound chamber and the right sound chamber are substantially cylindrical.

16. The electronic device of claim 15, wherein the opposite ends of the left sound chamber and the right sound chamber are provided with a first opening, the first opening is a concave structure, and the concave direction of the first opening of the left sound chamber is pointed to the other end of the left sound chamber.

17. The electronic device of claim 16, wherein the left sound chamber and the right sound chamber each defines a recess, the recess is a rectangular structure.

18. The electronic device of claim 17, wherein the recess defines a second opening, the second opening is an oval structure, and the second opening is configured to receive the diaphragm.

19. The electronic device of claim 18, wherein the speaker further comprises a drum paper, a support portion, and a voice coil, the drum paper is received in a third opening, the support portion is configured to support the drum paper, the drum paper defines a fourth opening, a bottom of the voice coil is secured to an end of the fourth opening, and the fourth opening is configured to receive a dust cap.
